(19) United States
(12) Patent Application Publication
(10) Pub. No.: US 2012/0246328 A1
(43) Pub. Date: Sep. 27, 2012

(54) PROTOCOL INTERWORKING DEVICE FOR NETWORK TELEPHONE SYSTEM AND METHOD FOR USING THE SAME

(75) Inventors: JUN SONG, Shanghai (CN); SONG GUO, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 13/103,110

(22) Filed: May 9, 2011

(30) Foreign Application Priority Data
Mar. 21, 2011 (CN) 201110067205.8

(51) Int. Cl. G06F 15/16

(52) U.S. Cl. 709/228

(57) ABSTRACT

A protocol interworking device communicates with at least one first network telephone terminal supporting a first protocol and at least one second network telephone terminal supporting a second protocol. The protocol interworking device includes a protocol converter supporting both the first and second protocols, and a transferring telephone enabled to communicate with both the first and second network telephone terminals by the protocol converter. When the first network telephone terminal sends a call request for calling the second network telephone terminal to the protocol interworking device, the transferring telephone hangs up with the first network telephone terminal and sends another call request to call the second network telephone terminal. When successfully connecting to the second network telephone terminal, the transferring telephone reconnects with the first network telephone terminal, and the first and network telephone terminals communicate with each other through the protocol interworking device.

### BACKGROUND

1. Technical Field

The present disclosure relates to network telephone communication, particularly to a protocol interworking device for network telephone system and a method for using the same.

2. Description of Related Art

Many types of network communication protocols, such as H.323 protocol, Session Initiation Protocol (SIP), Media Gateway Control Protocol (MGCP), and Media Gateway controller (Megaco), can be used in network telephone communication, i.e., used as network telephone protocols. Network communication terminals (e.g., personal computers and mobile phones) supporting at least one of these network telephone protocols can be used as network telephone terminals. However, many network communication terminals can support only one type of network telephone protocols, and are incompatible with network telephone communication using other types of network telephone protocols. That is, a network telephone terminal supporting one type of the network telephone protocols will have difficulty in communication with a network telephone terminal supporting another type of the network telephone protocols.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of an exemplary embodiment of protocol interworking device communicating with two network telephone terminals supporting different network telephone protocols.

FIG. 2 is a flowchart of a method for using the protocol interworking device shown in FIG. 1.

### DETAILED DESCRIPTION

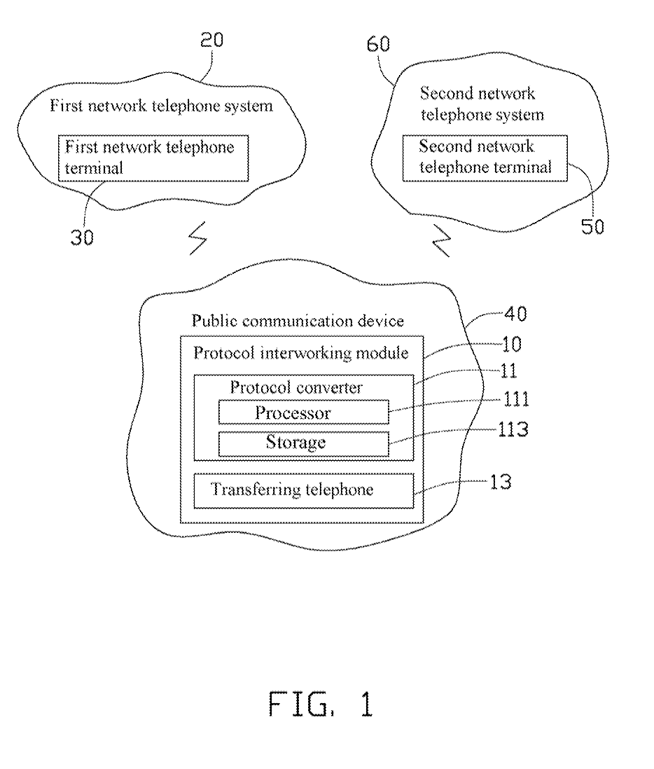

FIG. 1 is a block diagram of an exemplary embodiment of a protocol interworking device 10 communicating with at least one first network telephone terminal 30 and at least one second network telephone terminal 50. The first network telephone terminal 30 is located in a first network telephone system 20 using a first network telephone protocol. The second network telephone terminal 50 is located in a second network telephone system 60 using a second network telephone protocol. The first and second network telephone protocols can be any two different protocols selected from H.323 protocol, Session Initiation Protocol (SIP), Media Gateway Control Protocol (MGCP), Media Gateway controller (Megaco), or other common network telephone protocols.

In this embodiment, the first network telephone protocol used by the first network telephone system 20 is MGCP, and the second network telephone protocol used by the second network telephone system 60 is SIP. The protocol interworking device 10 can be a customer premise equipment (CPE) located in a public communication network 40. In this embodiment, the public communication network 40 is the Internet. Both the first network telephone system 20 and the second network system 60 can communicate with the public communication network 40 by typical methods.

The protocol interworking device 10 includes a protocol converter 11 and a transferring telephone 13 electrically connected to the protocol converter 11. The first network telephone terminal 30 can communicate with the protocol converter 11 through the first network telephone system 20 and the public communication network 40, and the second network terminal 50 can communicate with the protocol converter 11 through the second network telephone system 60 and the public communication network 40. The protocol converter 11 includes a processor 111 and storage 113. The processor 111 supports both MGCP and SIP, and is able to convert data packets based on MGCP to data packets based on SIP and vice versa. The storage 113 can temporarily stores data to be processed (e.g., converted to be based on MGCP/SIP) by the processor 111. The transferring telephone 13 supports at least one of MGCP and SIP, and can be further enabled to communicate with both the first network telephone terminal 30 and the second network telephone terminal 50 by the protocol converter 11. Furthermore, the processor 111 can further support more types of network telephone protocols, such as the aforementioned H.323 protocol, Megaco, etc., and be able to convert data packets based on any one of all above network telephone protocols to data packets based on any other.

The present protocol interworking device 10 enables network telephone terminals supporting different network telephone protocols to communicate with each other. For example, when the first network telephone terminal 30 calls the second network telephone terminal 50, the first network telephone terminal 30 sends a call request based on MGCP for calling the second network telephone terminal 50 to the protocol interworking device 10. When the protocol interworking device 10 receives the call request based on MGCP, the transferring telephone 13 connects to the first network telephone terminal 30. Upon connecting to the first network telephone terminal 30, the transferring telephone 13 flashes the first network telephone terminal 30 (i.e., quickly hangs up with the first network telephone terminal 30, and prepares for quickly reconnecting with the first network telephone 30), and sends a call request based on SIP to call the second network telephone terminal 50.

When the second network telephone terminal 50 successfully receives the call request sent from the transferring telephone 13, the second network telephone terminal 50 sends a response signal to the transferring telephone 13. Upon receiving the response signal, the protocol interworking device 10 identifies that the transferring telephone 13 successfully connects to the second network telephone terminal 50. That is, the transferring telephone 13 is capable of communicating with the second network telephone terminal 50 through network telephone communication based on SIP. Thus, the transferring telephone 13 reconnects with the first network telephone terminal 30, such that the transferring telephone 13 is also capable of communicating with the first network telephone terminal 30 through network telephone communication based on MGCP. In this way, the first network telephone terminal 30 and the second network telephone terminal 50 can communicate with each other through the protocol interworking device 10. In the communication between the first network telephone terminal 30 and the second network telephone terminal 50, voice data packets based on MGCP are sent from the first network telephone terminal 30, and are converted to voice data packets based on SIP and sent to the second network telephone terminal 50 by the protocol converter 11. Voice data packets based on SIP are sent from the second network telephone terminal 50, and are converted to voice data packets based on the MGCP and sent to the first network telephone terminal 30 by the protocol converter 11.

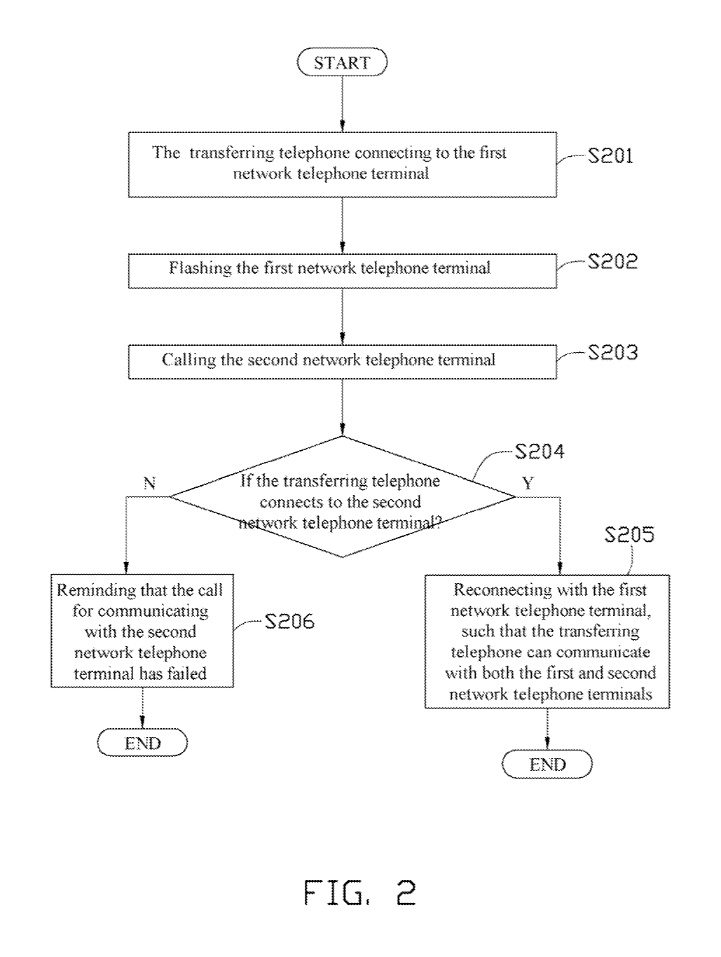

Also referring to FIG. 2, a flowchart of a method for using the protocol interworking device 10 is provided. The present method is using the first network telephone terminal 30 to call the second network telephone terminal 50 through the protocol interworking device 10, and thus establishing a network telephone communication between the first network telephone terminal 30 and the second network telephone terminal 50 that are respectively located in different network telephone systems (e.g., 20, 60) using different network telephone protocols (e.g., MGCP, SIP). The present method includes steps as follows.

When the first network telephone terminal 30 calls the second network telephone terminal 50, it sends a call request based on MGCP. The call request based on MGCP is transmitted to the protocol interworking device 10 through the first network telephone system 20 and the public communication network 40. When the protocol interworking device 10 receives the call request based on MGCP, the transferring telephone 13 connects to the first network telephone terminal 30 (Step S201).

Upon connecting to the first telephone terminal 30, the transferring telephone 13 flashes the first network telephone terminal 30 (Step S202). That is, the transferring telephone 13 quickly hangs up with the first network telephone terminal 30, and prepares for quickly reconnecting with the first network telephone 30.

Subsequently, the transferring telephone 13 sends a call request based on SIP to call the second network telephone terminal 50 (Step S203). The call request based on SIP is transmitted to the second network telephone terminal 50 through the public communication network 40 and the second network telephone system 60.

The protocol interworking device 10 then identifies if the transferring telephone 13 connects to the second network telephone terminal 50 (Step S204). When the second network telephone terminal 50 successfully receives the call request based on SIP, it sends a response signal to the transferring telephone 13. Upon receiving the response signal, the protocol interworking device 10 identifies that the transferring telephone 13 has successfully connected to the second network telephone terminal 50 and can communicate with the second network telephone terminal 50 through network telephone communication based on SIP. Thus, the transferring telephone 13 reconnects with the first network telephone terminal 30, such that the transferring telephone 13 can also communicate with the first network telephone terminal 30 through network telephone communication based on MGCP (Step S205). In this way, the first network telephone terminal 30 and the second network telephone terminal 50 can communicate with each other through the protocol interworking device 10, and thereby establishing network telephone communication.

If the second network telephone terminal 50 does not receive the call request based on SIP, no response signal is sent to the transferring telephone 13. Thus, the protocol interworking device 10 identifies that the transferring telephone 13 has failed to connect to the second network telephone terminal 50. In this situation, the transferring telephone 13 reconnects with the first network telephone terminal 30, and generates predetermined alarm audio signals to remind user of the first network telephone terminal 30 that this call for communicating with the second network telephone terminal 50 has failed (Step S206).

Furthermore, after Step S202, the protocol interworking device 10 can first check the second network telephone system 60 and the second network telephone terminal 50 to determine if they can further support the first network communication protocol used by the first network telephone terminal 30, i.e., MGCP. If the second network telephone system 60 and the second network telephone terminal 50 can also support MGCP, then the transferring telephone 13 directly transfers the call request based on MGCP to the second network telephone system 50 through the public communication network 40 and the second network telephone system 60. Thus, the first and second network telephone terminals 30, 50 can directly communicate with each other. If the second network telephone system 60 is unable to support MGCP, then Step S203 is performed.

The present disclosure enables network telephone terminals (e.g., 30, 50) that are respectively located in different network telephone systems (e.g., 20, 60) using different network telephone protocols (e.g., MGCP, SIP) to communicate with each other through network telephone communication. Compared with conventional protocol interworking devices used in network telephone communication, the protocol interworking device 10 of the present disclosure is simpler and spends less cost. By using the public communication network 40 (e.g., Internet) to connect the network telephone terminals (e.g., 30, 50) to the transferring telephone 13, use of the protocol interworking device 10 is simplified.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A protocol interworking device communicating with at least one first network telephone terminal located in a first network system based on a first network telephone protocol and at least one second network telephone terminal located in a second network system based on a second network telephone protocol, comprising:
a protocol converter supporting both the first and second network telephone protocols; and
a transferring telephone electrically connected to the protocol converter and enabled to communicate with both the first and second network telephone terminals by the protocol converter; wherein when the first network telephone terminal sends a call request for calling the second network telephone terminal to the protocol interworking device, the transferring telephone hangs up with the first network telephone terminal and sends another call request to call the second network telephone terminal; and when successfully connecting to the second network telephone terminal, the transferring telephone reconnects with the first network telephone terminal, such that the first and network telephone terminals communicate with each other through the protocol interworking device.

2. The protocol interworking device as claimed in claim 1, wherein the first and second network telephone protocols are any two different ones selected from H.323 protocol, Session Initiation Protocol (SIP), Media Gateway Control Protocol (MGCP), and Media Gateway controller (Megaco).

3. The protocol interworking device as claimed in claim 1, wherein the protocol interworking device is located in a public communication network, both the first network telephone system and the second network telephone system communicating with the public communication network, such that the first network telephone terminal communicates with the interworking module through the first network telephone system and the public communication network, and the second network telephone terminal communicates with the interworking module through the second network telephone system and the public communication network.

4. The network telephone system as claimed in claim 1, wherein the transferring telephone supports at least one of the first and second network telephone protocols.

5. The network telephone system as claimed in claim 1, wherein the protocol converter supports both the first and second network telephone protocols; when the first and network telephone terminals communicate with each other through the protocol interworking device, voice data packets based on the first network telephone protocol are sent from the first network telephone terminal, and are converted to voice data packets based on the second network protocol and sent to the second network telephone terminal by the protocol converter; and voice data packets based on the second network telephone protocol are sent from the second network telephone terminal, and are converted to voice data packets based on the first network protocol and sent to the first network telephone terminal by the protocol converter.

6. A method of using a protocol interworking device to enable at least one first network telephone terminal located in a first network system based on a first network telephone protocol and at least one second network telephone terminal located in a second network system based on a second network telephone protocol to communicate with each other, comprising:
using the first network telephone terminal to send a call request for calling the second network telephone terminal to the protocol interworking device, thereby connecting the first network telephone terminal to the protocol interworking device;
hanging up with the first network telephone terminal;
using the protocol interworking device to call the second network telephone terminal;
identifying if the protocol interworking device connects to the second network telephone terminal; and
if the protocol interworking device connects to the second network telephone terminal, reconnecting the protocol interworking device with the first network telephone terminal, such that the first and second network telephone terminals communicate with each other through the protocol interworking device.

7. The method as claimed in claim 6, wherein the first and second network telephone protocols are any two different ones selected from H.323 protocol, Session Initiation Protocol (SIP), Media Gateway Control Protocol (MGCP), and Media Gateway controller (Megaco).

8. The method as claimed in claim 6, further comprising:
if the protocol interworking device fails to connect to the second network telephone terminal, reconnecting the first network telephone terminal with the protocol interworking device and generating alarm signals.

9. The method as claimed in claim 6, further comprising:
locating the protocol interworking device in a public communication network; and
both the first and second network telephone terminals communicating with the protocol interworking device through the public communication network.

10. The method as claimed in claim 6, further comprising:
when the first and network telephone terminals communicate with each other through the protocol interworking device, converting voice data packets based on the first network telephone protocol and sent from the first network telephone terminal to voice data packets based on the second network protocol, and sending the converted voice data packets to the second network telephone terminal; and converting voice data packets based on the second network telephone protocol and sent from the second network telephone terminal to voice data packets based on the first network protocol, and sending the converted voice data packets to the first network telephone terminal.

11. The method as claimed in claim 6, further comprising:
if the second network telephone terminal further supports the first network telephone protocol, using the protocol interworking device to transfer the call request sent by the first network telephone terminal to the second network telephone terminal, such that the first and second network telephone terminals directly communicate with each other.
